(19) United States
(12) Patent Application Publication
(10) Pub. No.: US 2022/0051679 A1
(43) Pub. Date: Feb. 17, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventors: KAN KURODA, TOKYO (JP); NORIKO TOTSUKA, TOKYO (JP); CHIE KAMADA, TOKYO (JP); YUKI TAKEDA, TOKYO (JP); KAZUYA TATEISHI, TOKYO (JP); YUICHIRO KOYAMA, TOKYO (JP); EMIRU TSUNOO, TOKYO (JP); AKIRA TAKAHASHI, TOKYO (JP); HIDEAKI WATANABE, TOKYO (JP); AKIRA FUKUI, TOKYO (JP); YOSHINORI MAEDA, TOKYO (JP); HIROAKI OGAWA, TOKYO (JP)

(21) Appl. No.: 17/433,351

(22) PCT Filed: Feb. 18, 2020
(86) PCT No.: PCT/JP2020/006379

§ 371 Date: Aug. 24, 2021

(30) Foreign Application Priority Data
Mar. 5, 2019 (JP) 2019-039180

(51) Int. Cl. G10L 17/22; G10L 15/10; G10L 17/02; G10L 15/22

(52) U.S. Cl. CPC G10L 17/22; G10L 15/22; G10L 17/02; G10L 15/10

(57) ABSTRACT

A control section performs control to give notification of information regarding a previous dialogue on the basis of each status of participants in dialogue. For example, the information regarding the previous dialogue includes information regarding a significant word extracted from a speech of the previous dialogue. In this case, the information regarding the previous dialogue further includes, for example, additional information related to the significant word. For example, when one of utterers currently in dialogue makes an utterance indicative of intention to call up information, the control section perform control to give notification of the information regarding a previous dialogue in which all utterers currently in dialogue participated.

### TECHNICAL FIELD

The present technology relates to an information processing apparatus, an information processing method, and a program. More particularly, the technology relates to an information processing apparatus capable of supporting the resumption of interrupted dialogues.

### BACKGROUND ART

In home agents released in recent years, their dialogue systems are implemented in such a manner that the system responds to a speech uttered by a user. The operation of these systems is triggered by a user clearly uttering an activation word toward the system. Thus, when users are conversing with each other, the system does not offer its functions to their dialogue. Incidentally, PTL 1 discloses how irregularly occurring dialogues between unspecified persons are analyzed, for example.

### CITATION LIST

### Patent Literature

### [PTL 1]

### SUMMARY

### Technical Problem

An object of the present technology is to support the resumption of interrupted dialogues (including monologues).

### Solution to Problem

According to the idea of the present technology, there is provided an information processing apparatus including a control section configured to perform control in such a manner as to give notification of information regarding a previous dialogue on the basis of each status of participants in dialogue.

According to the present technology, the control section performs control to give notification of the information regarding a previous dialogue on the basis of the status of participants in dialogue. For example, the information regarding the previous dialogue may include information regarding a significant word extracted from a speech of the previous dialogue. In this case, the information regarding the previous dialogue may further include, for example, information related to the significant word. The information processing apparatus may further include a speech storage section configured to store a speech spanning a most recent predetermined period of time out of collected speeches, for example. The control section may acquire the information regarding the previous dialogue on the basis of the speech stored in the speech storage section.

For example, when any one of utterers currently in dialogue makes an utterance indicative of intention to call up information, the control section may perform control in such a manner as to give notification of the information regarding the previous dialogue in which all utterers currently in dialogue participated.

In another example, when the number of participants in dialogue is changed, the control section may perform control in such a manner as to give notification of the information regarding the previous dialogue in which all the utterers currently in dialogue following the change in the number of participants in dialogue participated.

In another example, when there has been no utterance for a predetermined period of time, the control section may perform control in such a manner as to give notification of the information regarding a previous monologue. In this case, the control section may perform control to give notification of the information regarding the previous monologue, before repeatedly giving notification of the information regarding the previous monologue at predetermined intervals until an utterance is made.

In another example, when an utterer newly participates in dialogue, or when an utterer newly participates in dialogue and also makes an utterance indicative of intention to call up information, the control section may perform control in such a manner as to give notification of the information regarding a dialogue prior to the participation of the new utterer. In this case, the information processing apparatus may further include, for example, an utterer identification section configured to perform utterer identification based on a collected speech signal. On the basis of the utterer identification by the utterer identification section, the control section may determine whether an utterer has newly participated in dialogue. In this case, in a case where the control section determines that it is acceptable to notify the utterer newly participating in dialogue of the information regarding the prior dialogue, the control section may perform control in such a manner as to give notification of the information regarding the prior dialogue.

According to the present technology, as outlined above, control is performed in such a manner as to give notification of information regarding a previous dialogue on the basis of each status of participants in dialogue. This makes it possible to support the resumption of interrupted dialogues (including monologues).

### BRIEF DESCRIPTION OF DRAWINGS

FIG. 1 is a block diagram depicting a configuration example of an information processing apparatus as a first embodiment.

FIG. 2 is a flowchart depicting an example of processing steps performed by an information processing section to update persons in dialogue and to add a timestamp.

FIG. 3 is a flowchart depicting an example of processing steps performed by the information processing section to call up a keyword for recollection.

FIG. 4 is a diagram for explaining a specific example of processing performed by the information processing apparatus.

FIG. 5 is a block diagram depicting a configuration example of the information processing section in a case of generating a response sentence including information regarding significant words.

FIG. 6 is a flowchart depicting another example of the processing steps performed by the information processing section to call up a keyword for recollection.

FIG. 7 is a diagram for explaining another specific example of the processing performed by the information processing apparatus.

FIG. 8 is a block diagram depicting a configuration example of an information processing apparatus as a second embodiment.

FIG. 9 is a flowchart (½) depicting an example of processing steps performed by the information processing section to update persons in dialogue, add a timestamp, and call up a keyword for recollection.

FIG. 10 is a flowchart (½) depicting an example of processing steps performed by the information processing section to update persons in dialogue, add a timestamp, and call up a keyword for recollection.

FIG. 11 is a diagram for explaining another specific example of the processing performed by the information processing apparatus.

FIG. 12 is a block diagram depicting a configuration example of an information processing apparatus as a third embodiment.

FIG. 13 is a flowchart depicting another example of the processing steps performed by the information processing section to call up a keyword for recollection.

FIG. 14 is a diagram for explaining another specific example of the processing performed by the information processing apparatus.

FIG. 15 is a block diagram depicting a configuration example of an information processing apparatus as a fourth embodiment.

FIG. 16 is a flowchart depicting an example of processing steps performed by the information processing section to update persons in dialogue and call up a keyword for recollection.

FIG. 17 is a diagram for explaining another specific example of the processing performed by the information processing apparatus.

FIG. 18 is a flowchart depicting another example of the processing steps performed by the information processing section to update persons in dialogue and call up a keyword for recollection.

FIG. 19 is a diagram for explaining another specific example of the processing performed by the information processing apparatus.

FIG. 20 is a block diagram depicting a hardware configuration example of the information processing section.

### DESCRIPTION OF EMBODIMENTS

Preferred embodiments for implementing the present technology (referred to as the “embodiment(s)”) are described below. Incidentally, the description will be given under the following headings:

1. First embodiment

2. Second embodiment

3. Third embodiment

4. Fourth embodiment

5. Alternative examples

### 1. FIRST EMBODIMENT

### (Configuration Example of the Information Processing Apparatus)

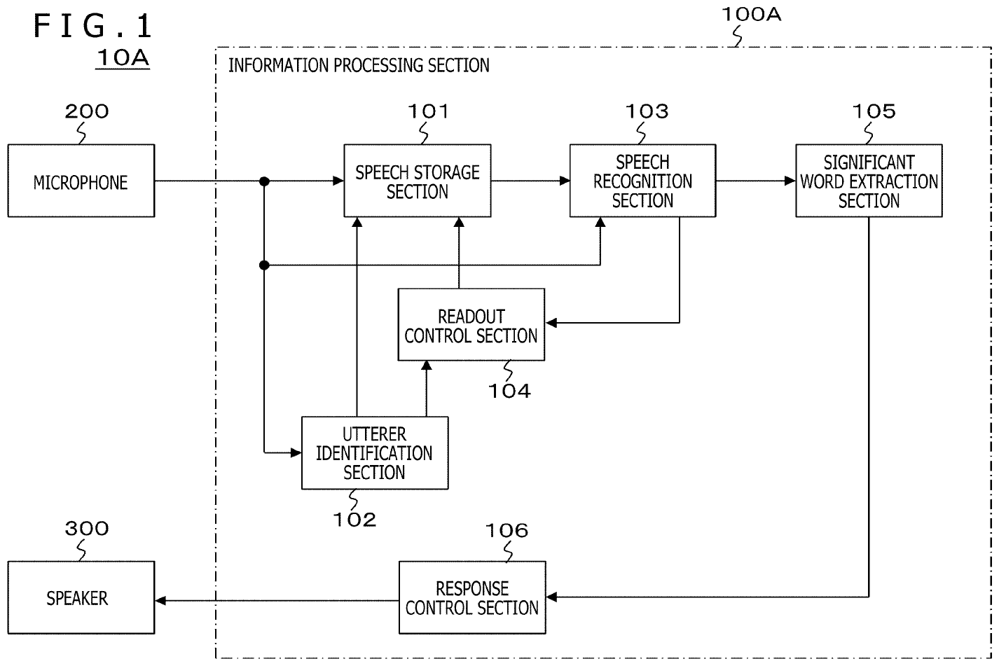

FIG. 1 depicts a configuration example of an information processing apparatus 10A as the first embodiment. The information processing apparatus 10A includes an information processing section 100A, a microphone 200 constituting a sound collection section, and a speaker 300 making up a sound output section. The microphone 200 sends to the information processing section 100A a speech signal obtained by collecting a speech uttered by a user (i.e., utterer). The speaker 300 outputs a speech based on the speech signal sent from the information processing section 100A.

When any one of the users currently in dialogue makes an utterance indicative of the intention to call up information on the basis of the speech signal input from the microphone 200, the information processing section 100A outputs to the speaker 300 speech signals for giving notification of information regarding a previous dialogue in which all users currently in dialogue participated. The information processing section 100A thus performs processes such as steps to update persons in dialogue, add a timestamp, and call up a keyword for recollection.

The information processing section 100A includes a speech storage section 101, an utterer identification section 102, a speech recognition section 103, a readout control section 104, a significant word extraction section 105, and a response control section 106. The speech storage section 101 stores the speech signals input from the microphone 200. For example, the speech signals stored in the speech storage section 101 in excess of a predetermined period of time are overwritten and deleted. This places the speech storage section 101 continuously in a state of storing the speech signals spanning a most recent predetermined period of time. The period of time may be set beforehand to 15 minutes, for example.

The utterer identification section 102 identifies the utterer by comparison with previously registered speech characteristics of users on the basis of the speech signal input from the microphone 200. The utterer identification section 102 further holds information regarding which users are among the persons in dialogue.

Here, in a case where an utterer is not among the persons in dialogue, the utterer identification section 102 adds that utterer to the persons in dialogue. In a case where any one of the persons in dialogue has not uttered a word for a predetermined period of time, the utterer identification section 102 removes that person from those in dialogue. In such a manner, where there is a person added to or removed from those in dialogue by the utterer identification section 102, a timestamp denoting the time at which the person was added or removed is added accordingly to the speech storage section 102 in association with the persons in the immediately preceding dialogue.

On the basis of the speech signal input from the microphone 200, the speech recognition section 103 detects a speech indicative of the intention to call up information such as “What were we talking about?” or a similar speech. In this case, the speech recognition section 103 may either estimate the intention of the utterance by converting the speech signal into text data or detect directly from the speech signal a keyword for calling up specific information.

When the speech recognition section 103 detects an utterance indicative of the intention to call up information, the readout control section 104 reads from the speech storage section 101 the speech signals spanning a predetermined period of time, for example, of approximately one to two minutes preceding the timestamp associated with the persons currently in dialogue, and sends the retrieved speech signals to the speech recognition section 103.

The speech recognition section 103 performs speech recognition processing on the speech signals read from the speech storage section 101, thereby converting the speech signals into text data. The significant word extraction section 105 extracts significant words from the text data obtained through conversion by the speech recognition section 103.

In this case, the words deemed significant in view of an existing conversation corpus are extracted as significant words from the text data of which the degree of certainty is at least equal to a predetermined threshold, for example. Incidentally, the algorithm for extracting significant words may be any suitable algorithm and is not limited to anything specific. The words extracted by the significant word extraction section 105 may not embrace all significant words. Conceivably, the most significant word alone may be extracted. As another alternative, multiple words may be extracted in descending order of significance.

The response control section 106 generates a response sentence including the significant words extracted by the significant word extraction section 105, and outputs to the speaker 300 a speech signal corresponding to the response sentence. For example, in a case where “∘∘” and “××” are extracted as the significant words, a response sentence “You were talking about ‘∘∘’ and ‘××’” is generated.

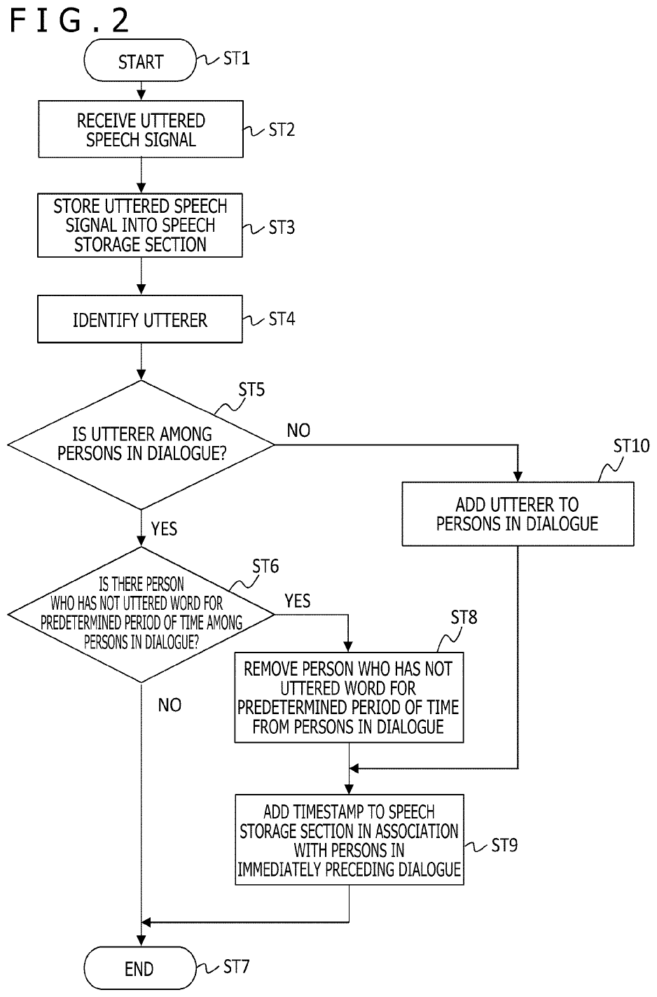

The flowchart of FIG. 2 depicts an example of processing steps performed by the information processing section 100A to update persons in dialogue and to add a timestamp. The processing of this flowchart is repeated at predetermined intervals.

In step ST1, the information processing section 100A starts the processing. Then, in step ST2, the information processing section 100A receives an uttered speech signal from the microphone 200. Then, in step ST3, the information processing section 100A stores the uttered speech signal into the speech storage section 101.

Next, in step ST4, the information processing section 100A identifies the utterer based on the uttered speech signal from the microphone 200. In step ST5, the information processing section 100A determines whether the utterer is among the persons in dialogue.

When the utterer is among the persons in dialogue, the information processing section 100A goes to step ST6. In step ST6, the information processing section 100A determines whether any one of the persons in dialogue has not uttered a word for a predetermined period of time. In a case where there is no person who has not uttered a word for a predetermined period of time, the information processing section 100A goes to step ST7 and terminates the series of the steps.

In a case where, in step ST6, there is a person who has not uttered a word for the predetermined period of time, the information processing section 100A goes to step ST8. In step ST8, the information processing section 100A removes from those in dialogue the person who has not uttered a word for the predetermined period of time. Thereafter, the information processing section 100A goes to the process of step ST9.

In a case where the utterer is not among the persons in dialogue in step ST5, the information processing section 100A goes to step ST10. In step ST10, the information processing section 100A adds the utterer to the persons in dialogue. Thereafter, the information processing section 100A goes to the process of step ST9. In step ST9, the information processing section 100A adds to the speech storage section 101 a timestamp in association with the persons in the immediately preceding dialogue.

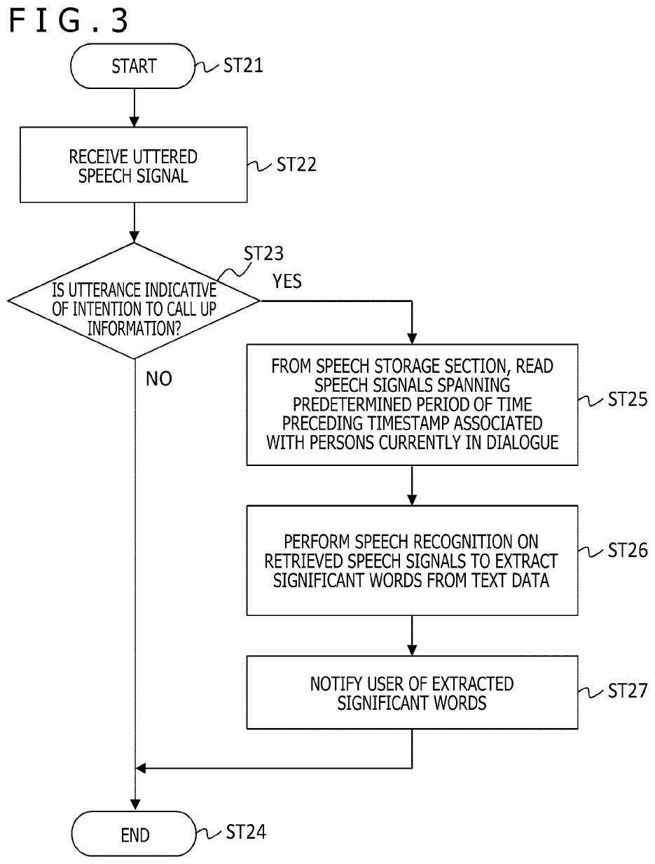

The flowchart of FIG. 3 depicts an example of processing steps performed by the information processing section 100A to call up a keyword for recollection. The processing of this flowchart is repeated at predetermined intervals.

In step ST21, the information processing section 100A starts the processing. Then, in step ST22, the information processing section 100A receives an uttered speech signal from the microphone 200. Then, in step ST23, the information processing section 100A determines whether the utterance indicates the intention to call up information. When the utterance is not indicative of the intention to call up information, the information processing section 100A goes to step ST24 and terminates the series of the steps.

When the utterance is indicative of the intention to call up information in step ST23, the information processing section 100A goes to step ST25. In step ST25, the information processing section 100A reads from the speech storage section 101 the speech signals spanning a predetermined period of time preceding the most recent timestamp associated with the persons currently in dialogue.

Then, in step ST26, the information processing section 100A performs speech recognition on the retrieved speech signals to extract significant words from text data. Then, in step ST27, the information processing section 100A generates a response sentence including the extracted significant words, and outputs the speech signal of the response sentence to the speaker 300 to notify the users of the significant words. Following the process of step ST27, the information processing section 100A goes to step ST24 and terminates the series of the steps.

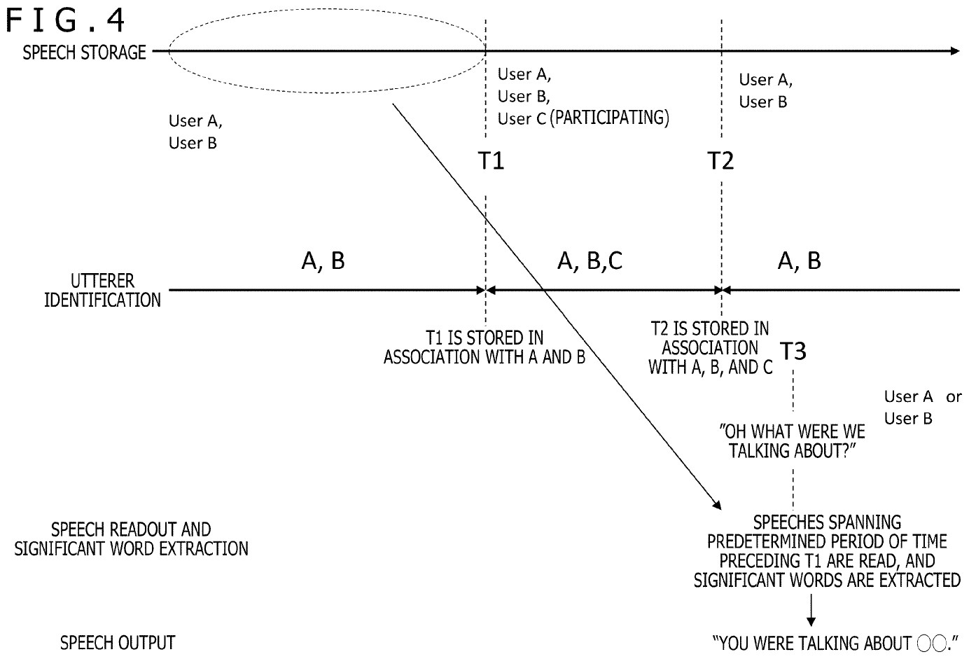

Explained next with reference to FIG. 4 is a specific example of processing performed by the information processing apparatus 10A depicted in FIG. 1. Up to time T1, users A and B are identified as the persons in dialogue. At time T1, a user C is added to the persons in dialogue. Up to time T2, the users A and B are identified as the persons in dialogue. At time T2, the user C is removed from the persons in dialogue. After time T2, the users A and B are identified as the persons in dialogue.

Here, at time T1, the current time T1 is stored into the speech storage section 101 as the timestamp associated with the users A and B. At time T2, the current time T2 is stored into the speech storage section 101 as the timestamp associated with the users A, B, and C.

Up to time T1, the dialogue between the users A and B is, for example, about “washing machine” and “drying machine.” For example, the user A may utter “ . . . about how to use the drying machine attached to the washing machine.” In response, the user B may utter “ . . . it may not be a good idea to dry and damage the towels for children.”

At time T1, the user C newly participates in dialogue. Between time T1 and time T2, the dialogue is about a topic other than “washing machine” and “drying machine.” For example, the user C may utter, “Are you done with the bath? Can I take a bath now?” In response, the user A may utter, “Oh, my child is still in there, but he is only playing, so I think you can take a bath together.” The user C may in turn utter, “Oh, in that case, I'll wait a bit.”

After time T2, with the user C not in dialogue, suppose that the user A or B makes an utterance indicative of the intention to call up information, such as “Oh, what were we talking about?” In this case, the speech recognition section 103 detects that the utterance indicates the intention to call up information.

That detection triggers readout, from the speech storage section 101, of the speech signals of a previous dialogue between the users A and B currently in dialogue. In this example, the speech signals spanning a predetermined period of time of approximately one to two minutes preceding the most recent timestamp T1 associated with the users A and B are read from the speech storage section 101. The speech recognition section 103 converts the retrieved speech signals into text data, and the significant word extraction section 105 extracts significant words from the text data. For example, “washing machine” and “drying machine” are extracted as the significant words.

The information related to the significant words extracted by the significant word extraction section 105 is then sent to the response control section 106. The response control section 106 generates a response sentence including the significant words, and outputs a speech signal corresponding to the response sentence to the speaker 300. For example, a response sentence such as “You were talking about the washing machine and drying machine” is generated, and is audibly output from the speaker 300.

In such a manner, the information processing apparatus 10A depicted in FIG. 1 can notify the users A and B of details of the previous dialogue interrupted by the participation of the user C in dialogue, thereby supporting the resumption of the interrupted dialogue.

Further, in the information processing apparatus 10A depicted in FIG. 1, the speech recognition section 103 does not continuously convert the uttered speech signals of users into text data and supply the text data to the significant word extraction section 105 for the process of extracting significant words. Instead, only when a user makes an utterance indicative of the intention to call up information, does the apparatus process the speech signals spanning a corresponding predetermined period of time in the past, which eases the processing load involved. Also, in a case where the function of the significant word extraction section 105 is implemented by an external server, as will be discussed later, the communication load involved can be alleviated.

It is to be noted that the information processing apparatus 10A depicted in FIG. 1 may conceivably be configured in such a manner that some of the functions of the information processing section 100A such as those of the speech storage section 101, the speech recognition section 103, and the significant word extraction section 105 are implemented by external servers such as cloud servers. Also, in the above examples involving the information processing apparatus 10A depicted in FIG. 1, the response control section 106 outputs the speech signal corresponding to the response sentence to the speaker 300 that in turn audibly notify the users of the details of the previous dialogue. Alternatively, the users may be notified of the details of the previous dialogue displayed on a display part. In this case, the response control section 106 outputs to the display part the speech signal arranged to display the response sentence. This alternative, of which the details will not be discussed further, also applies to the other embodiments to be described below.

Also, in the above examples involving the information processing apparatus 10A depicted in FIG. 1, the response control section 106 of the information processing section 100A generates the response sentence including the significant words extracted by the significant word extraction section 105. Alternatively, there may be a configuration in which the response control section 106 generates a response sentence that includes not only the significant words extracted by the significant word extraction section 105 but also information related to the extracted significant words.

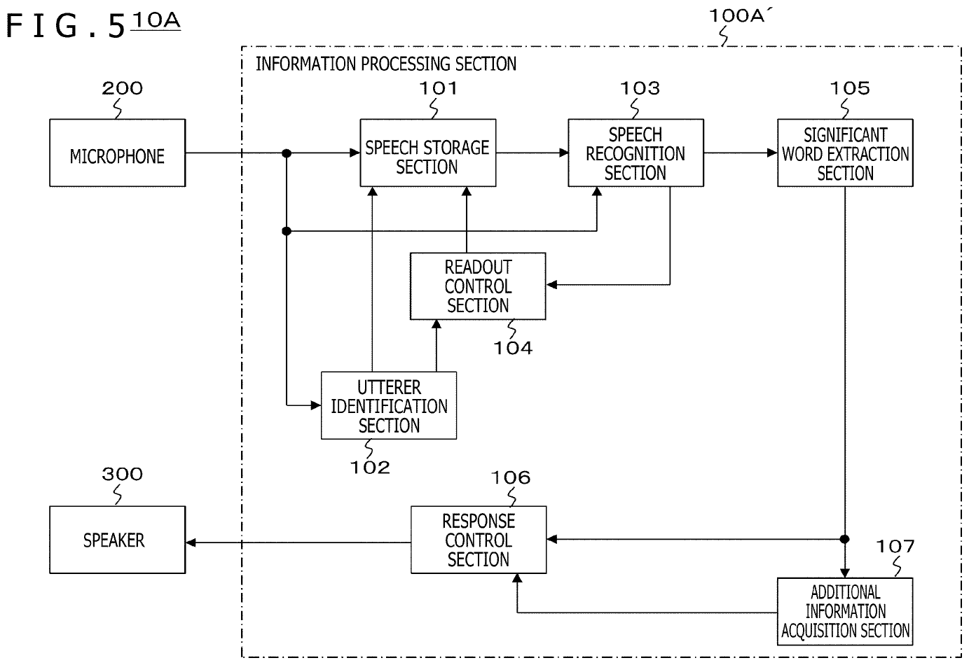

FIG. 5 depicts a configuration example of an information processing section 100A′ in the above case. In FIG. 5, the sections corresponding to those in FIG. 1 are designated by the same reference signs. The information processing section 100A′ includes an additional information acquisition section 107, in addition to the speech storage section 101, the utterer identification section 102, the speech recognition section 103, the readout control section 104, the significant word extraction section 105, and the response control section 106. In an alternative configuration, the function of the additional information acquisition section 107 may conceivably be implemented by an external server such as a cloud server.

The additional information acquisition section 107 acquires additional information related the significant words extracted by the significant word extraction section 105. In this case, the additional information acquisition section 107 acquires the additional information by making inquiries, for example, to a dictionary database in the information processing section 100A′ or to dictionary databases on networks such as the Internet.

The response control section 106 generates a response sentence including the significant words extracted by the significant word extraction section 105 and the additional information acquired by the additional information acquisition section 107, and outputs a speech signal corresponding to the response sentence to the speaker 300. For example, in a case where “∘∘” is extracted as a significant word and “××” is acquired as additional information related to “∘∘,” a response sentence such as “You were talking about ‘∘∘.’ ‘∘∘’ is related to ‘××’” is generated.

It is to be noted that the other sections of the information processing section 100A′, of which the details will not be discussed further, are configured similar to the information processing section 100A depicted in FIG. 1.

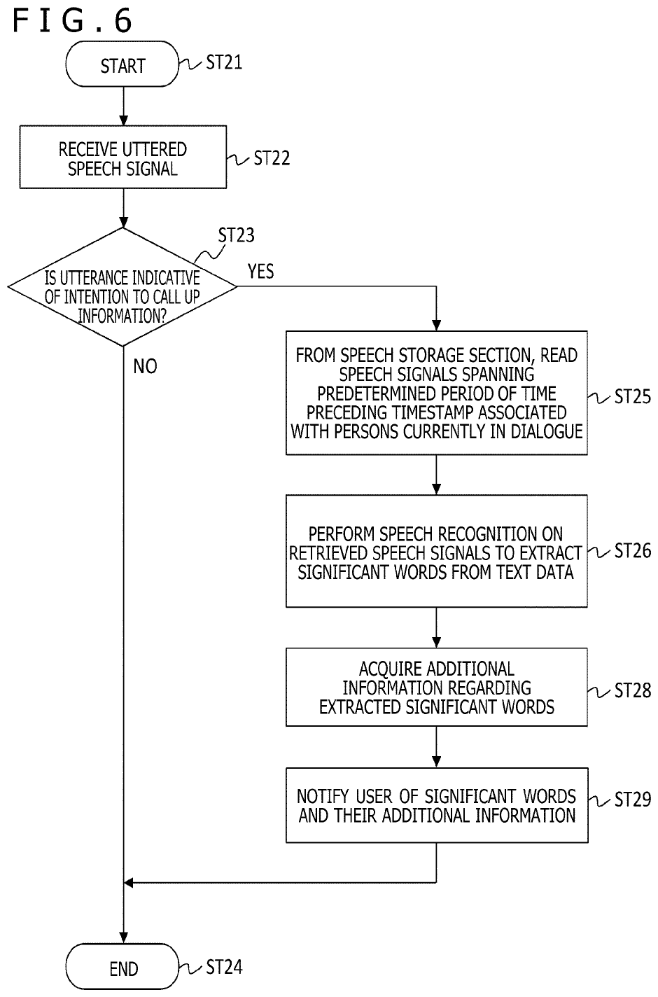

The flowchart of FIG. 6 depicts an example of processing steps performed by the information processing section 100A′ to call up a keyword for recollection. In FIG. 6, the steps corresponding to those in FIG. 3 are designated by the same reference signs and will not be discussed further in detail. The processing of this flowchart is repeated at predetermined intervals. Incidentally, the processing steps performed by the information processing section 100A′ to update persons in dialogue and to add a timestamp are similar to those carried out by the information processing section 100A in FIG. 1 (see FIG. 2), the details of the steps being omitted below.

Following the process of step ST26, the information processing section 100A′ goes to step ST28. In step ST28, the information processing section 100A′ acquires additional information related to extracted significant words. In step ST29, the information processing section 100A′ generates a response sentence including the extracted significant words and the acquired additional information, and outputs a speech signal of the response sentence to the speaker 300 for notification to the users. Following the process of step ST29, the information processing section 100A′ goes to step ST24 and terminates the series of the steps.

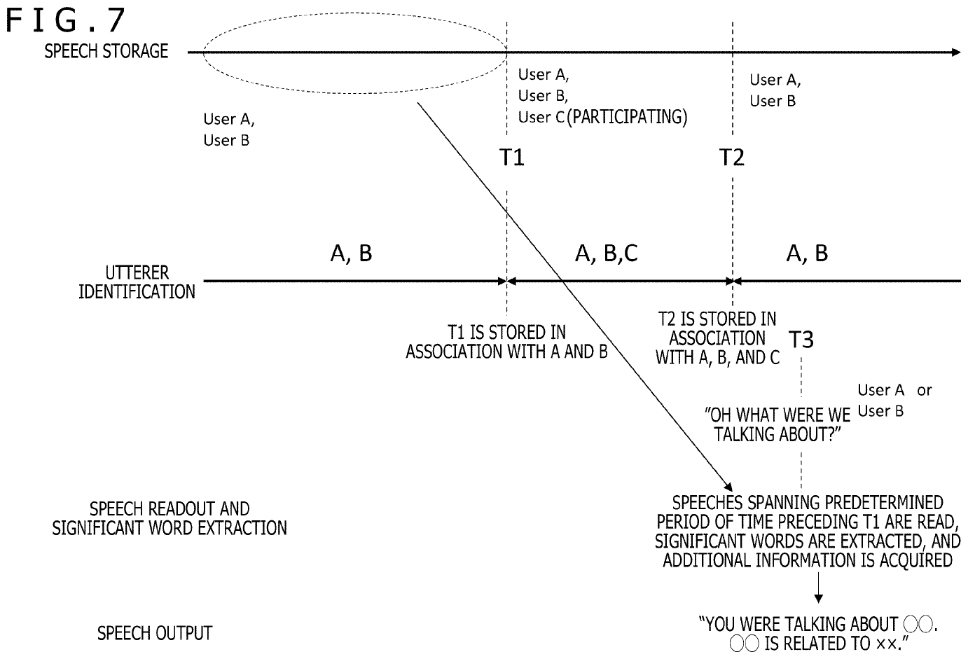

Explained next with reference to FIG. 7 is a specific example of processing performed by the information processing apparatus 10A depicted in FIG. 5. Up to time T1, the users A and B are identified as the persons in dialogue. At time T1, the user C is added to the persons in dialogue. Up to time T2, the users A and B are identified as the persons in dialogue. At time T2, the user C is removed from the persons in dialogue. After time T2, the users A and B are identified as the persons in dialogue.

Here, at time T1, the current time T1 is stored into the speech storage section 101 as the timestamp associated with the users A and B. At time T2, the current time T2 is stored into the speech storage section 101 as the timestamp associated with the users A, B, and C.

Up to time T1, the dialogue between the users A and B is, for example, about “T-REX.” For example, the user A may utter “ . . . T-REX is the tyrannosaurus we saw in that movie, isn't it?” In response, the user B may utter, “Yeah, T-REX is cool. But if it actually exists, it may eat me up . . . ”

At time T1, the user C newly participates in dialogue. Between time T1 and time T2, the dialogue is about a topic other than “T-REX.” For example, the user C may utter, “Come here and help me carry the baggage.” In response, the users A and B may utter “Sure.”

After time T2, with the user C not in dialogue, suppose that the user A or B makes an utterance indicative of the intention to call up information, such as “Oh, what were we talking about?” In this case, the speech recognition section 103 detects that the utterance indicates the intention to call up information.

That detection triggers readout, from the speech storage section 101, of the speech signals of a previous dialogue between the users A and B currently in dialogue. In this example, the speech signals spanning a predetermined period of time of approximately one to two minutes preceding the most recent timestamp T1 associated with the users A and B are read from the speech storage section 101. The speech recognition section 103 converts the retrieved speech signals into text data, and the significant word extraction section 105 extracts significant words from the text data. For example, “T-REX” is extracted as the significant word. The additional information acquisition section 107 acquires additional information related to the extracted significant word. For example, additional information descriptive of “a carnivorous dinosaur that lived in North America in the Cretaceous period” is acquired.

The information regarding the significant word extracted by the significant word extraction section 105 and the additional information acquired by the additional information acquisition section 107 are then sent to the response control section 106. The response control section 106 generates a response sentence including the significant word and the additional information, and outputs a speech signal corresponding to the response sentence to the speaker 300. For example, a response sentence such as “You were talking about T-REX. T-REX is a carnivorous dinosaur that lived in North America in the Cretaceous period” is generated, and is audibly output from the speaker 300.

In such a manner, the information processing apparatus 10A depicted in FIG. 5 can notify the users A and B of details of the previous dialogue interrupted by the participation of the user C in dialogue, thereby supporting the resumption of the interrupted dialogue. Further, the information processing apparatus 10A in FIG. 5 can notify the users of not only the significant words included in the previous dialogue but also the additional information related to the significant words. This makes it possible, for example, to support children in recollecting what they learned and give them the opportunity to acquire more knowledge at the same time.

It is to be noted that the response control section 106 of the information processing section 100A is configured to generate the response sentence that includes not only significant words but also information related to the significant words, as in the above-described information processing apparatus 10A in FIG. 5. This configuration, of which the details will not be discussed further, also applies to the other embodiments to be described below.

### 2. SECOND CONFIGURATION

### (Configuration Example of the Information Processing Apparatus)

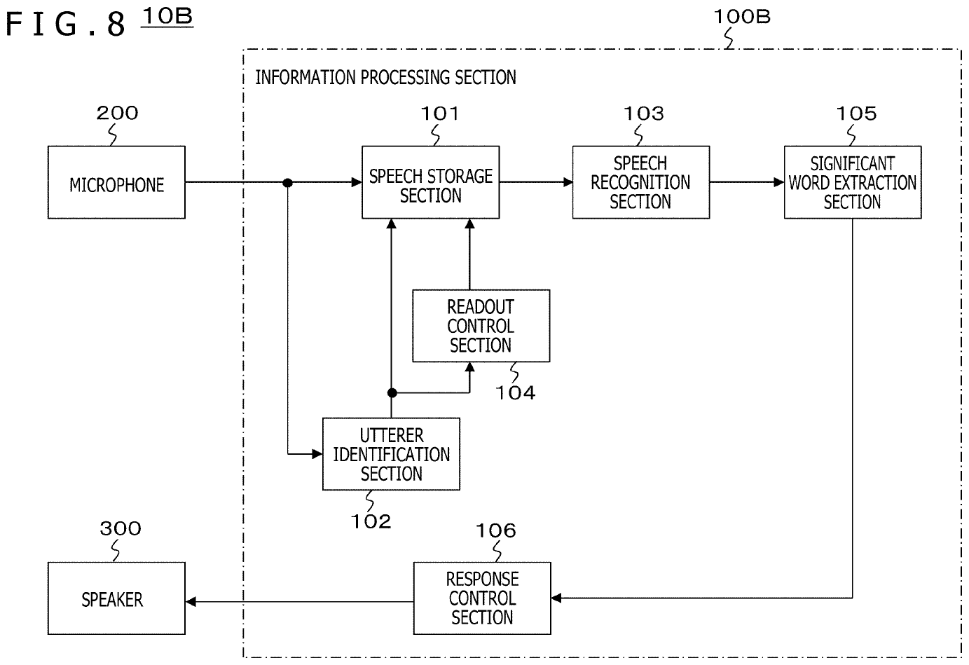

FIG. 8 depicts a configuration example of an information processing apparatus 10B as the second embodiment. In FIG. 8, the sections corresponding to those in FIG. 1 are designated by the same reference signs, and their detailed explanations will be omitted below where appropriate. The information processing apparatus 10B includes an information processing section 100B, a microphone 200 constituting a sound collection section, and a speaker 300 making up a sound output section.

When the number of users in dialogue (number of participants in dialogue) is changed on the basis of the speech signal input from the microphone 200, the information processing section 100B outputs to the speaker 300 a speech signal giving notification of information regarding the previous dialogue in which all users currently in dialogue following the change in the number of participants took part. The information processing section 100B thus performs processes such as steps to update persons in dialogue, add a timestamp, and call up a keyword for recollection.

The information processing section 100A includes a speech storage section 101, an utterer identification section 102, a speech recognition section 103, a readout control section 104, a significant word extraction section 105, and a response control section 106. The speech storage section 101 stores the speech signals input from the microphone 200. For example, the speech signals stored in the speech storage section 101 in excess of a predetermined period of time are overwritten and deleted. This places the speech storage section 101 continuously in a state of storing the speech signals spanning a most recent predetermined period of time. The period of time may be set beforehand to 15 minutes, for example.

The utterer identification section 102 identifies the utterer by comparison with previously registered speech characteristics of users on the basis of the speech signal input from the microphone 200. The utterer identification section 102 further holds information regarding which users are among the persons in dialogue.

Here, in a case where an utterer is not among the persons in dialogue, the utterer identification section 102 adds that utterer to the persons in dialogue. In a case where any one of the persons in dialogue has not uttered a word for a predetermined period of time, the utterer identification section 102 removes that person from those in dialogue. In such a manner, in a case where there is a person added to or removed from those in dialogue by the utterer identification section 102, a timestamp presenting the time at which the person was added or removed is added accordingly to the speech storage section 102 in association with the persons in the immediately preceding dialogue.

When the number of persons in dialogue is changed, the readout control section 104 reads from the speech storage section 101 the speech signals spanning a predetermined period of time, for example, of approximately one to two minutes preceding the timestamp associated with the changed number of persons in dialogue. The readout control section 104 sends the retrieved speech signals to the speech recognition section 103.

The speech recognition section 103 performs speech recognition processing on the speech signals read from the speech storage section 101 to convert the speech signals into text data. The significant word extraction section 105 extracts significant words from the text data obtained through conversion by the speech recognition section 103. The response control section 106 generates a response sentence including the significant words extracted by the significant word extraction section 105, and outputs a speech signal corresponding to the response sentence to the speaker 300.

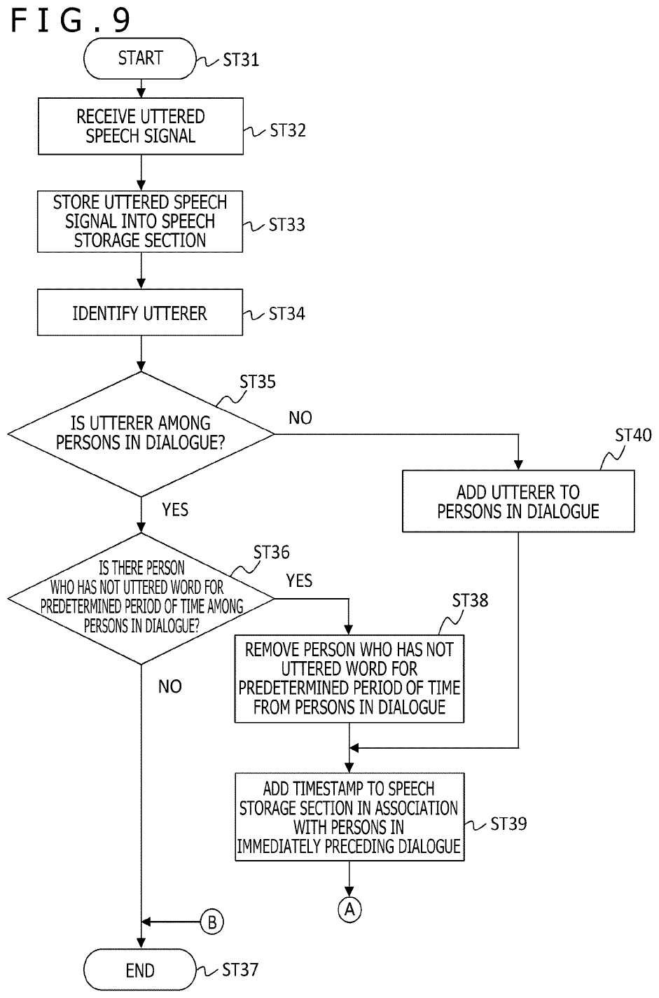

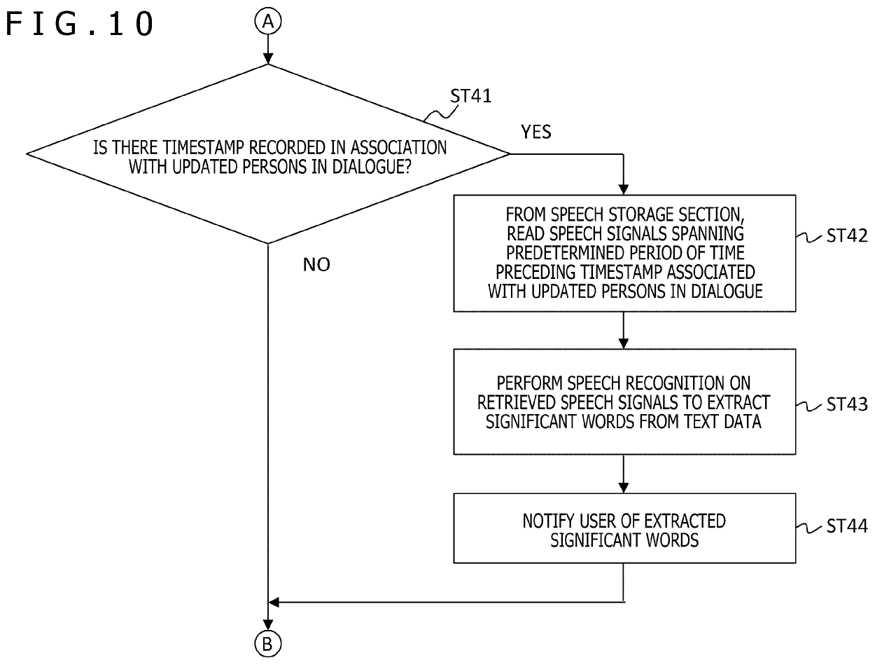

The flowcharts of FIGS. 9 and 10 depict examples of processing steps performed by the information processing section 100B to update persons in dialogue, add a timestamp, and call up a keyword for recollection. The processing of these flowcharts is repeated at predetermined intervals.

In step ST31, the information processing section 100B starts the processing. In step ST32, the information processing section 100B receives an uttered speech signal from the microphone 200. Then, in step ST33, the information processing section 100B stores the uttered speech signal into the speech storage section 101.

Next, in step ST34, the information processing section 100B identifies the utterer based on the uttered speech signal from the microphone 200. In step ST35, the information processing section 100B determines whether the utterer is among the persons in dialogue.

When the utterer is among the persons in dialogue, the information processing section 100B goes to step ST36. In step ST36, the information processing section 100B determines whether any one of the persons in dialogue has not uttered a word for a predetermined period of time. In a case where there is no person who has not uttered a word for a predetermined period of time, the information processing section 100B goes to step ST37 and terminates the series of the steps.

In a case where, in step ST36, there is a person who has not uttered a word for the predetermined period of time, the information processing section 100B goes to step ST38. In step ST38, the information processing section 100B removes from those in dialogue the person who has not uttered a word for the predetermined period of time. Thereafter, the information processing section 100B goes to the process of step ST39.

Also, in a case where the utterer is not among the persons in dialogue in step ST35, the information processing section 100B goes to step ST40. In step ST40, the information processing section 100B adds the utterer to the persons in dialogue. Thereafter, the information processing section 100B goes to the process of step ST39. In step ST39, the information processing section 100B adds to the speech storage section 101 a timestamp in association with the persons in the immediately preceding dialogue.

Following the process of step ST39, the information processing section 100B goes to step ST41. In step ST41, the information processing section 100B determines whether there is a timestamp recorded in association with the updated persons in dialogue. When no such timestamp is recorded, the information processing section 100B goes to step ST37 and terminates the series of the steps.

When there is a timestamp associated with the updated persons in dialogue in step ST41, the information processing section 100B goes to step ST42. In step ST42, the information processing section 100B reads from the speech storage section 101 the speech signals spanning a predetermined period of time preceding the most recent timestamp associated with the updated persons in dialogue.

Then, in step ST43, the information processing section 100B performs speech recognition on the retrieved speech signals to extract significant words from text data. In step ST44, the information processing section 100B generates a response sentence including the extracted significant words, and outputs a speech signal of the response sentence to the speaker 300 notifying the users of the significant words. Following the process of step ST44, the information processing section 100B then goes to step ST37 and terminates the series of the steps.

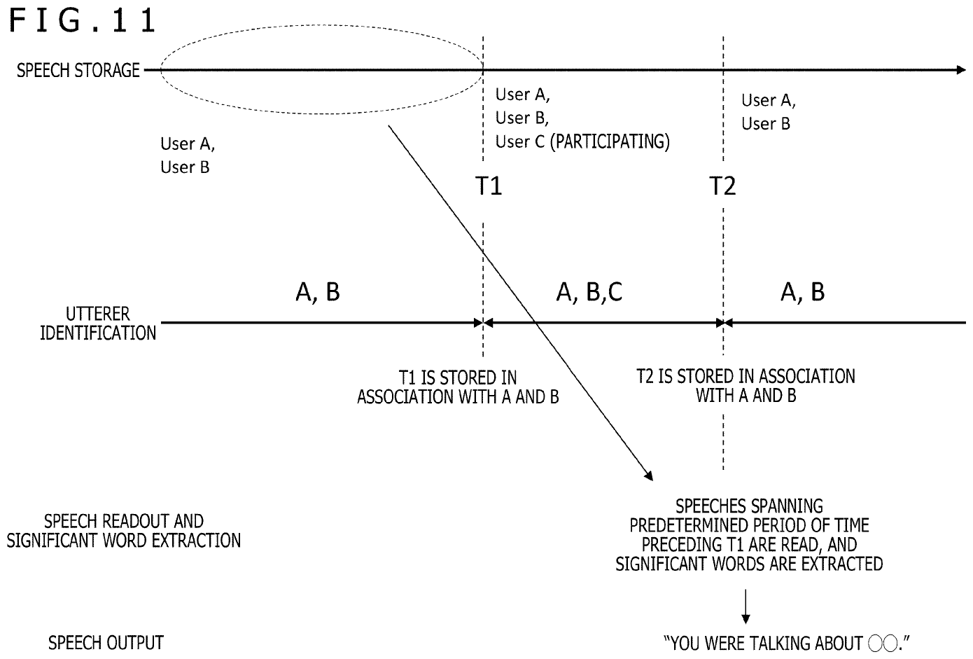

Explained next with reference to FIG. 11 is a specific example of processing performed by the information processing apparatus 10B depicted in FIG. 8. Up to time T1, the users A and B are identified as the persons in dialogue. At time T1, the user C is added to the persons in dialogue. Up to time T2, the users A and B are identified as the persons in dialogue. At time T2, the user C is removed from the persons in dialogue. After time T2, the users A and B are identified as the persons in dialogue.

Here, at time T1, the current time T1 is stored into the speech storage section 101 as a timestamp associated with the users A and B. At time T2, the current time T2 is stored into the speech storage section 101 as a timestamp associated with the users A, B, and C.

Up to time T1, the dialogue between the users A and B is about “washing machine” and “drying machine.” For example, the user A may utter “ . . . about how to use the drying machine attached to the washing machine.” In response, the user B may utter “ . . . it may not be a good idea to dry and damage the towels for children.”

At time T1, the user C newly participates in dialogue. Between time T1 and time T2, the dialogue is about a topic other than “washing machine” and “drying machine.” For example, the user C may utter, “Are you done with the bath? Can I take a bath now?” In response, the user A may utter, “Oh, my child is still in there, but he is only playing, so I think you can take a bath together.” The user C may in turn utter, “Oh, in that case, I'll wait a bit.”

Further, the user A may utter “By the way, there's something wrong with the shower of the bath recently.” In response, the user B may utter “Oh, that's right, sometimes it works and sometimes it doesn't.”

At time T2, the user C leaves the dialogue. This change in the number of persons in dialogue triggers a readout, from the speech storage section 101, of the speech signals of a previous dialogue between the users A and B following the change in the number of participants in dialogue. In this example, the speech signals spanning a predetermined period of time of approximately one to two minutes preceding the timestamp T1 associated with the users A and B are read from the speech storage section 101. The speech recognition section 103 converts the retrieved speech signals into text data, and the significant word extraction section 105 extracts significant words from the text data. For example, it is assumed that “washing machine” and “drying machine” are extracted as the significant words.

The information related to the significant words extracted by the significant word extraction section 105 is then sent to the response control section 106. The response control section 106 generates a response sentence including the significant words, and outputs a speech signal corresponding to the response sentence to the speaker 300. For example, a response sentence such as “You were talking about the washing machine and drying machine just a little while ago” is generated, and is audibly output from the speaker 300.

The audible output reminds the users A and B in dialogue of the details of the previous dialogue interrupted by the user C. The user A may then utter, for example, “Right, we were talking about the drying machine. It might be better to prepare a dedicated laundry box where you put only the clothes not for machine drying . . . ”

In such a manner, the information processing apparatus 10B depicted in FIG. 8 can notify the users A and B of the details of the previous dialogue interrupted by the participation of the user C, thereby supporting the resumption of the interrupted dialogue. Further, the information processing apparatus 10B in FIG. 8 gives automatic notification of the details of a previous dialogue without a user making an utterance indicative of the intention to call up information. This saves time and effort on the part of the users.

### 3. THIRD EMBODIMENT

### (Configuration Example of the Information Processing Apparatus)

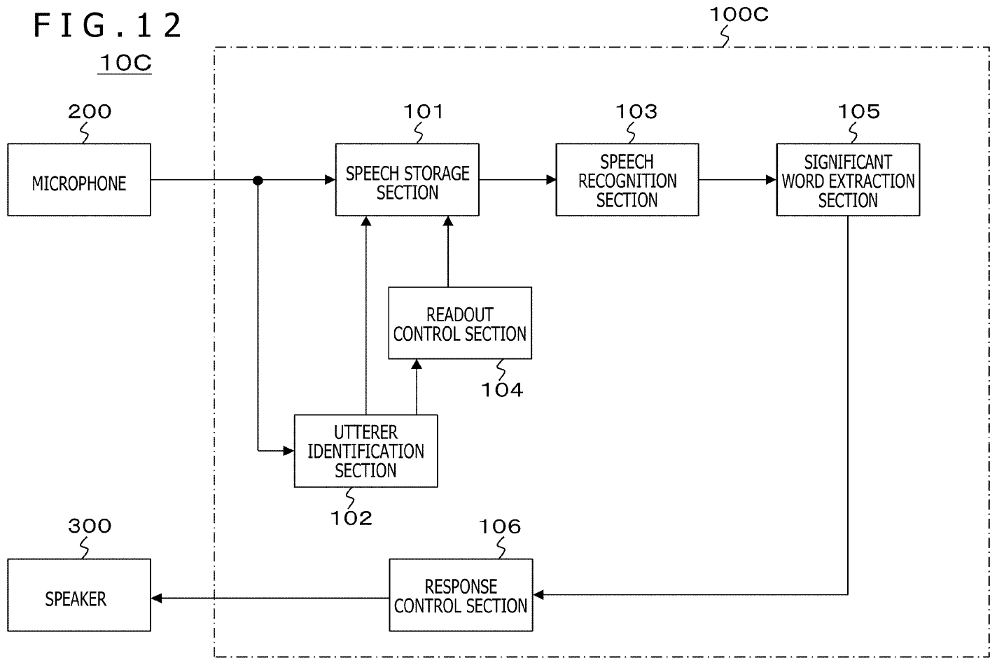

FIG. 12 depicts a configuration example of an information processing apparatus 10C as the third embodiment. In FIG. 12, the sections corresponding to those in FIG. 1 are designated by the same reference signs, and their detailed explanations will be omitted below where appropriate. The information processing apparatus 10C includes an information processing section 100C, a microphone 200 constituting a sound collection section, and a speaker 300 making up a sound output section.

When there is no utterance made over a predetermined period of time on the basis of the speech signal input from the microphone 200, the information processing section 100C outputs to the speaker 300 a speech signal for giving notification of information regarding one person talking to oneself in the past. That is, the information regarding one person previously in self-talk means monologue information with respect to one person talking to oneself in the past. The information processing section 100C thus performs processing steps to update persons in dialogue, add a timestamp, and call up a keyword for recollection.

The information processing section 100C includes a speech storage section 101, an utterer identification section 102, a speech recognition section 103, a readout control section 104, a significant word extraction section 105, and a response control section 106. The speech storage section 101 stores the speech signals input from the microphone 200. For example, the speech signals stored in the speech storage section 101 in excess of a predetermined period of time are overwritten and deleted. This places the speech storage section 101 continuously in a state of storing the speech signals spanning a most recent predetermined period of time. The period of time may be set beforehand to 15 minutes, for example.

The utterer identification section 102 identifies the utterer by comparison with previously registered speech characteristics of users on the basis of the speech signal input from the microphone 200. The utterer identification section 102 further holds information regarding which users are among the persons in dialogue.

Here, in a case where the utterer is not among the persons in dialogue, the utterer identification section 102 adds that utterer to the persons in dialogue. In a case where there is a person who has not uttered a word for a predetermined period of time among the persons in dialogue, the utterer identification section 102 removes that person from those in dialogue. In such a manner, in a case where there is a person added to or removed from those in dialogue by the utterer identification section 102, a timestamp is added accordingly to the speech storage section 102 in association with the persons in the immediately preceding dialogue.

Further, on the basis of the speech signal input from the microphone 200, the utterer identification section 102 detects whether no utterance has been made for a predetermined period of time. When there has been no utterance for a predetermined period of time, the readout control section 104 reads from the speech storage section 101 the speech signals spanning a predetermined period of time, for example, of approximately one to two minutes preceding the timestamp associated with a previous monologue. The readout control section 104 sends the retrieved speech signals to the speech recognition section 103.

The speech recognition section 103 performs speech recognition processing on the speech signals read from the speech storage section 101 to convert the speech signals into text data. The significant word extraction section 105 extracts significant words from the text data obtained through conversion by the speech recognition section 103. The response control section 106 generates a response sentence including the significant words extracted by the significant word extraction section 105, and outputs a speech signal corresponding to the response sentence to the speaker 300.

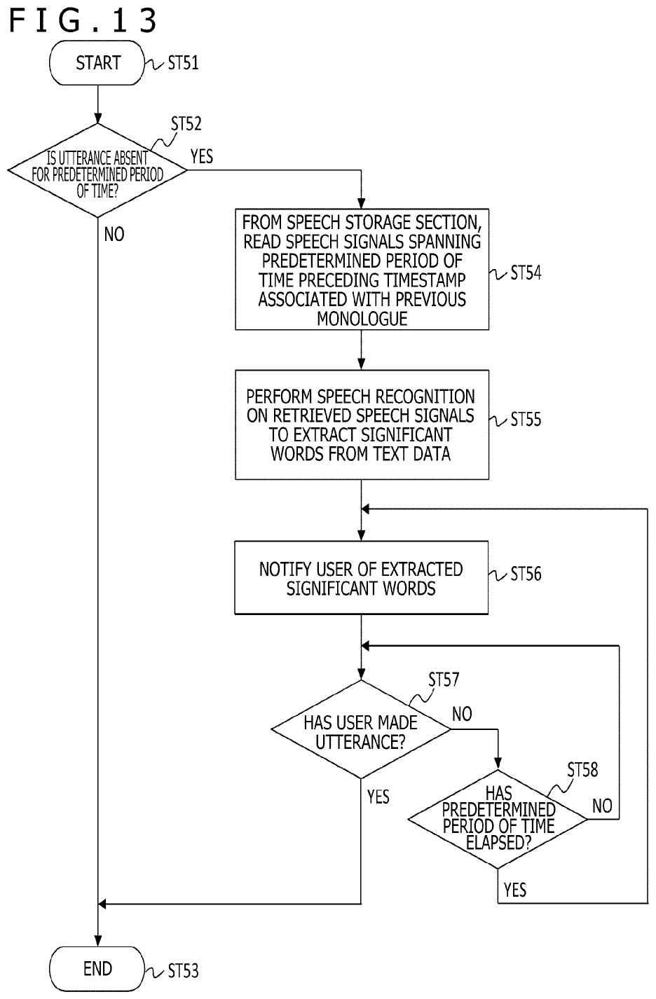

The flowchart of FIG. 13 depicts an example of processing steps performed by the information processing section 100C to call up a keyword for recollection. The processing of this flowchart is repeated at predetermined intervals. Incidentally, the processing steps performed by the information processing section 100C to update persons in dialogue and to add a timestamp are similar to those carried out by the information processing section 100A in FIG. 1 (see FIG. 2), the details of the steps being omitted below.

In step ST51, the information processing section 100C starts the processing. Then, in step ST52, the information processing section 100C determines whether an utterance has been absent for a predetermined period of time. When there has been an utterance, the information processing section 100C goes to step ST53 and terminates the series of the steps.

When an utterance has been absent for a predetermined period of time in step ST52, the information processing section 100C goes to step ST54. In step ST54, the information processing section 100C reads from the speech storage section 101 the speech signals spanning a previous predetermined period of time preceding the most recent timestamp associated with a previous monologue.

Then, in step ST55, the information processing section 100C performs speech recognition on the retrieved speech signals to extract significant words from text data. Then, in step ST56, the information processing section 100C generates a response sentence including the extracted significant words, and outputs a speech signal of the response sentence to the speaker 300 to notify the user of the significant words.

Then, in step ST57, the information processing section 100C determines whether the user has made an utterance. When there is an utterance made by the user, the information processing section 100C goes to step ST53 and terminates the series of the steps.

When there is no utterance made by the user in step ST57, the information processing section 100C goes to step ST58. In step ST58, the information processing section 100C determines whether a predetermined period of time has elapsed. When the predetermined period of time has not elapsed yet, the information processing section 100C returns to the process of step ST57. On the other hand, when the predetermined period of time has elapsed, the information processing section 100C returns to step ST56 and repeats the subsequent steps described above.

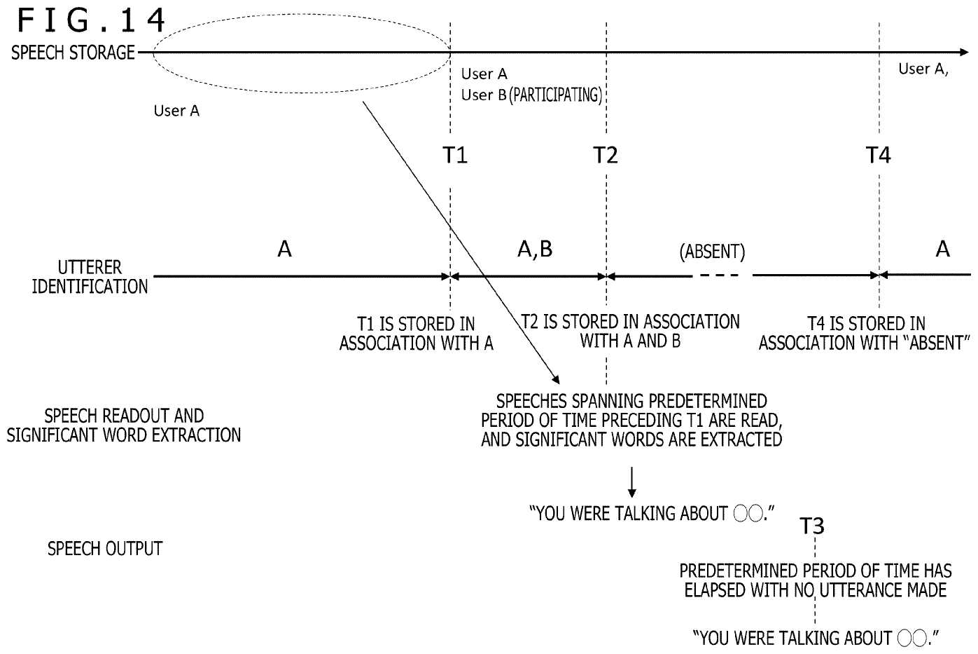

Explained next with reference to FIG. 14 is a specific example of processing performed by the information processing apparatus 10C depicted in FIG. 12. Up to time T1, the user A alone is identified as a person talking to oneself. At time T1, the user B is added to the person in self-talk, so that the users A and B are identified as the persons in dialogue up to time T2. At time T2, the users A and B are removed from the persons in dialogue, which leaves no persons in dialogue up to time T4. At time T4, the user A is added as a person in self-talk. After time T4, the user A alone is identified as the person in monologue.

Here, at time T1, the current time T1 is stored into the speech storage section 101 as the timestamp associated with the user A. At time T2, the current time T2 is stored into the speech storage section 101 as the timestamp associated with the users A and B. At time T4, the current time T4 is stored into the speech storage section 101 as the timestamp associated with the absence of users.

Up to time T1, the user A is in self-talk (monologue) about the topic of “medicine,” for example. For example, the user A may utter, “Now that dinner is finished, I need to take a medication. What was it the doctor prescribed?”

At time T1, the user B newly participates in dialogue. Between time T1 and time T2, the dialogue is about a topic other than “medicine.” For example, the user B may utter, “Grandpa, I′m going out, so please look after the house.” In response, the user A may utter, “If you're going out, will you buy me some barley tea? I'm out of stock.” In turn, the user B may utter, “OK, I'll buy some for you. I will be back around nine.”

Thereafter, there is no utterance made by the user A or B. At time T2, for example, it is detected that no utterance has been made for a predetermined period of time. The detection triggers readout of the speech signals of a previous monologue from the speech storage section 101. In this example, the speech signals spanning a predetermined period of time of approximately one to two minutes preceding the timestamp T1 associated with the user A are read from the speech storage section 101. The speech recognition section 103 converts the retrieved speech signals into text data, and the significant word extraction section 105 extracts significant words from the text data. For example, “medicine” is extracted as the significant word.

The information related to the significant word extracted by the significant word extraction section 105 is then sent to the response control section 106. The response control section 106 generates a response sentence including the significant word, and outputs a speech signal corresponding to the response sentence to the speaker 300. For example, a response sentence such as “You were talking about medicine until a little while ago” is generated, and is output audibly from the speaker 300.

On the other hand, when a user's utterance has not been detected, the sentence “You were talking about medicine until a little while ago” is again output audibly at time T3 upon elapse of a predetermined period of time. The audible output is thereafter repeated at predetermined intervals until a user's utterance is detected. In the illustrated example, an utterance such as “Oh right, I was supposed to take a medicine” is made at time T4.

In such a manner, the information processing apparatus 10C depicted in FIG. 12 can notify the user A of the details of the previous self-talk (monologue) interrupted by the participation of the user B, thereby supporting the resumption of the interrupted monologue. Further, in a case where the user A does not utter a word even when notified of the details of his or her monologue, i.e., where the user A fails to respond to the notification, the information processing apparatus 10C in FIG. 12 repeats the notification. This ensures that the details of the previous self-talk (monologue) are reported to the user A without fail. Whereas the above example has indicated that the information regarding the previous self-talk is reported if no utterance is made for a predetermined period of time, there may conceivably be a configuration in which the information regarding previous dialogues including monologues is reported.

### 4. FOURTH EMBODIMENT

### (Configuration Example of the Information Processing Apparatus)

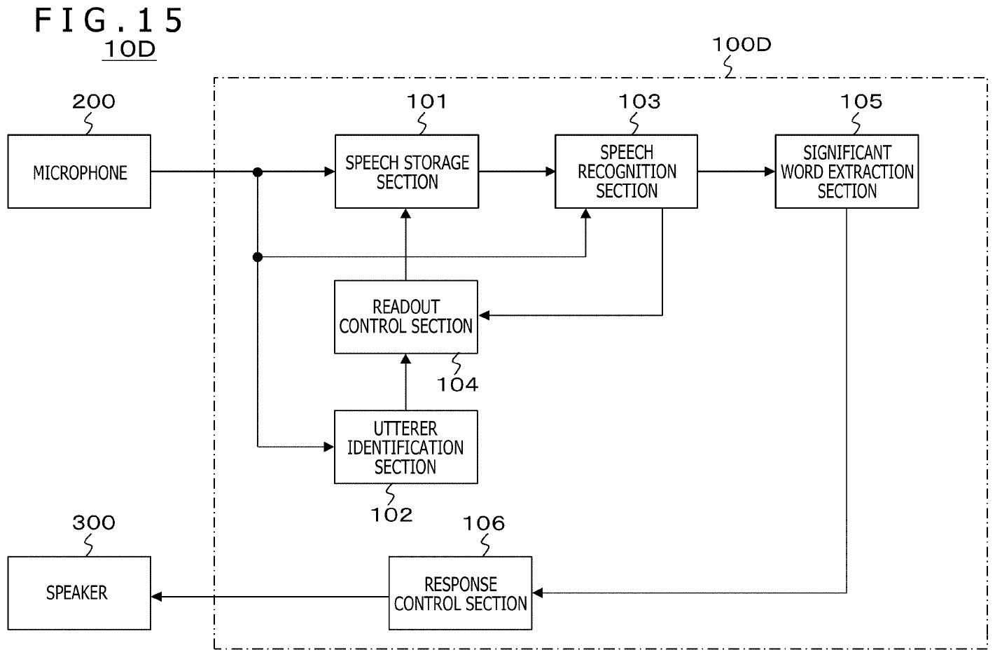

FIG. 15 depicts a configuration example of an information processing apparatus 10D as the fourth embodiment. In FIG. 15, the sections corresponding to those in FIG. 1 are designated by the same reference signs, and their detailed explanations will be omitted below where appropriate. The information processing apparatus 10D includes an information processing section 100D, a microphone 200 constituting a sound collection section, and a speaker 300 making up a sound output section.

When there is an utterer newly participating in dialogue on the basis of the speech signal input from the microphone 200, the information processing section 100D outputs to the speaker 300 the speech signals for giving notification of the information regarding the dialogue prior to the participation. The information processing section 100D thus performs processing steps to update persons in dialogue and to call up a keyword for recollection.

The information processing section 100D includes a speech storage section 101, an utterer identification section 102, a speech recognition section 103, a readout control section 104, a significant word extraction section 105, and a response control section 106. The speech storage section 101 stores the speech signals input from the microphone 200. For example, the speech signals stored in the speech storage section 101 in excess of a predetermined period of time are overwritten and deleted. This places the speech storage section 101 continuously in a state of storing the speech signals spanning a most recent predetermined period of time. The period of time may be set beforehand to 15 minutes, for example.

The utterer identification section 102 identifies the utterer by comparison with previously registered speech characteristics of users on the basis of the speech signal input from the microphone 200. The utterer identification section 102 further holds information regarding which users are among the persons in dialogue. Here, in a case where the utterer is not among the persons in dialogue, the utterer identification section 102 adds that utterer to the persons in dialogue. Also, in a case where there is a person who has not uttered a word for a predetermined period of time among the persons in dialogue, the utterer identification section 102 removes that person from those in dialogue.

On the basis of the speech signal input from the microphone 200, the speech recognition section 103 detects an utterance indicative of the intention to call up information, such as “What were you talking about?” or something similar to it. In this case, the speech recognition section 103 may either convert the speech signal into text data before estimating the intention, or detect keywords for calling up information directly from the speech signal.

When the speech recognition section 103 detects an utterance indicative of the intention to call up information, the readout control section 104 reads from the speech storage section 101 the speech signals spanning a predetermined period of time, for example, of approximately one to two minutes preceding the participation of the user making the utterance. The readout control section 104 sends the retrieved speech signals to the speech recognition section 103.

It is to be noted that there may be a case in which a user uttering the intention to call up information made a different utterance earlier and has participated in dialogue already. In that case, the utterer identification section 102 may, for example, have stored the time at which the user took part earlier in dialogue into the speech storage section 101 as a timestamp. On the basis of that timestamp, the speech signals spanning a predetermined period of time preceding the user's participation may be read out. In the description that follows, it is assumed that the user first makes an utterance indicative of the intention to call up information in order to participate in dialogue.

The speech recognition section 104 performs speech recognition processing on the speech signals read from the speech storage section 101 to convert the speech signals into text data. The significant word extraction section 105 extracts significant words from the text data obtained through conversion by the speech recognition section 104. The response control section 106 generates a response sentence including the significant words extracted by the significant word extraction section 105, and outputs a speech signal corresponding to the response sentence to the speaker 300.

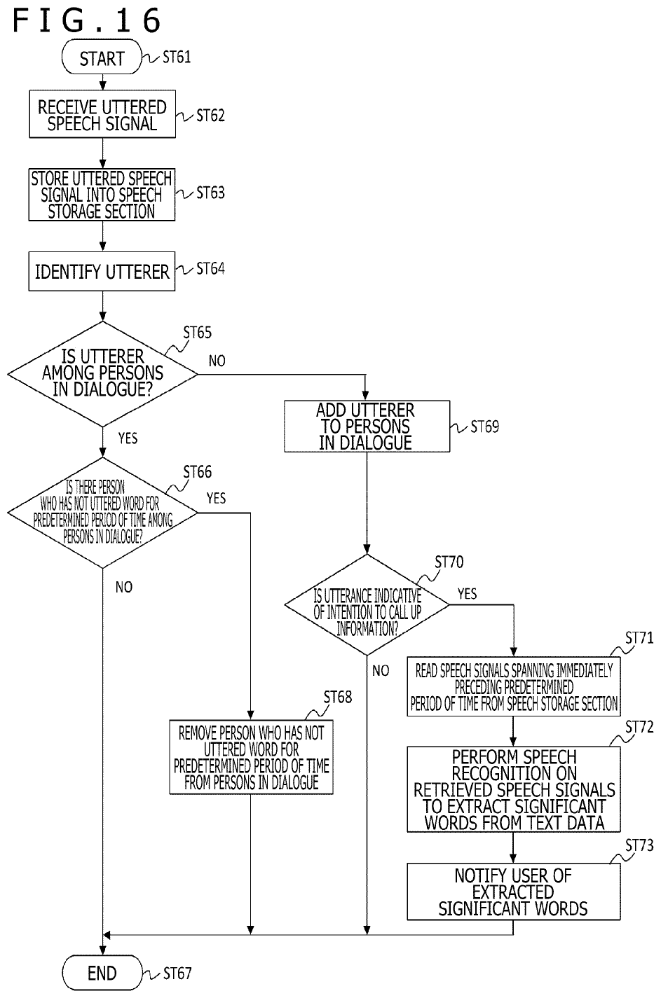

The flowchart of FIG. 16 depicts an example of processing steps performed by the information processing section 100D to update persons in dialogue and to call up a keyword for recollection. The processing of this flowchart is repeated at predetermined intervals.

In step ST61, the information processing section 100D starts the processing. Then, in step ST62, the information processing section 100D receives an uttered speech signal from the microphone 200. Then, in step ST63, the information processing section 100D stores the uttered speech signal into the speech storage section 101.

Next, in step ST64, the information processing section 100D identifies the utterer based on the uttered speech signal from the microphone 200. In step ST65, the information processing section 100D determines whether the utterer is among the persons in dialogue.

When the utterer is among the persons in dialogue, the information processing section 100D goes to step ST66. In step ST66, the information processing section 100D determines whether any one of the persons in dialogue has not uttered a word for a predetermined period of time. In a case where there is no person who has not uttered a word for a predetermined period of time, the information processing section 100D goes to step ST67 and terminates the series of the steps.

In a case where, in step ST66, there is a person who has not uttered a word for the predetermined period of time, the information processing section 100D goes to step ST68. In step ST68, the information processing section 100D removes from those in dialogue the person who has not uttered a word for the predetermined period of time. Thereafter, the information processing section 100D goes to step ST67 and terminates the series of the steps.

In a case where the utterer is not among the persons in dialogue in step ST65, the information processing section 100D goes to step ST69. In step ST69, the information processing section 100D adds the utterer to the persons in dialogue. Thereafter, the information processing section 100D goes to the process of step ST70. In step ST70, the information processing section 100D determines whether the utterance indicates the intention to call up information. In a case where the utterance does not indicate the intention to call up information, the information processing section 100D goes to step ST67 and terminates the series of the steps.

When the utterance is not indicative of the intention to call up information, the information processing section 100D goes to step ST67 and terminates the series of the steps. On the other hand, when the utterance is indicative of the intention to call up information, the information processing section 100D goes to step ST71. In step ST71, the information processing section 100D reads from the speech storage section 101 the speech signals spanning an immediately preceding predetermined period of time.

Then, in step ST72, the information processing section 100D performs speech recognition on the retrieved speech signals to extract significant words from text data. Then, in step ST73, the information processing section 100D generates a response sentence including the extracted significant words, and outputs a speech signal of the response sentence to the speaker 300 to notify the users of the significant words. After step ST73, the information processing section 100D then goes to step ST67 and terminates the series of the steps.

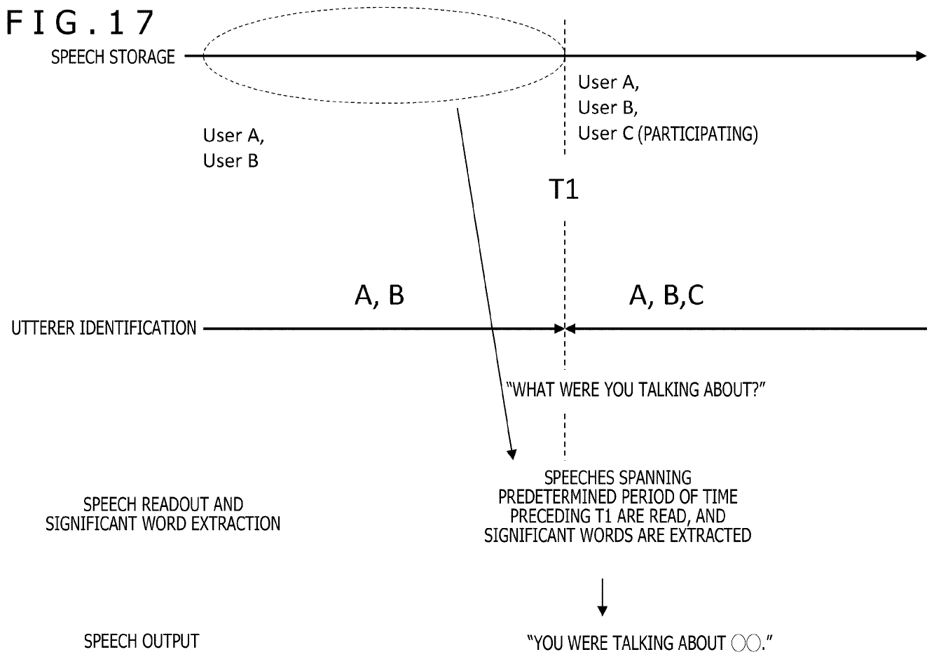

Explained next with reference to FIG. 17 is a specific example of processing performed by the information processing apparatus 10D depicted in FIG. 15. Up to time T1, the users A and B are identified as the persons in dialogue. At time T1, the user C is added to the persons in dialogue. After time T1, the persons A, B, and C are identified as the persons in dialogue.

Up to time T1, the dialogue between the users A and B is about the topic of “washing machine” and “drying machine.” For example, the user A may utter “ . . . about how to use the drying machine attached to the washing machine.” In response, the user B may utter “ . . . it may not be a good idea to dry and damage the towels for children.”

At time T1, the user C newly participates in dialogue. It is assumed that the user C at this point makes an utterance indicative of the intention to call up information, such as “What were you talking about?” Detection of this utterance by the speech recognition section 103 triggers a readout, from the speech storage section 101, of the speech signals spanning an immediately preceding predetermined period of time (i.e., a predetermined period of time preceding time T1) of approximately one to two minutes, for example. The speech recognition section 103 converts the retrieved speech signals into text data, and the significant word extraction section 105 extracts significant words from the text data. For example, “washing machine” and “drying machine” are extracted as the significant words.

The information related to the significant words extracted by the significant word extraction section 105 is sent to the response control section 106. The response control section 106 generates a response sentence including the significant words, and outputs a speech signal corresponding to the response sentence to the speaker 300. For example, a response sentence such as “You were talking about the washing machine and drying machine” is generated, and is audibly output from the speaker 300.

In such a manner, the information processing apparatus 10D depicted in FIG. 15 can notify the user C of the details of the dialogue between the users A and B prior to the participation of the user C. This allows the user C to catch up seamlessly on the topic of the dialogue between the users A and B.

It is to be noted that it has been explained above that when the user newly participating in dialogue makes an utterance indicative of the intention to call up information, the newly participating user is notified of the details of the dialogue between the other users prior to the participation. Alternatively, there may be a configuration in which whenever a user newly participates in dialogue, the newly participating user is automatically notified of the details of the dialogue between other users prior to the participation. In this case, there is no need for the speech recognition section 103 to detect whether the utterance is indicative of the intention to call up information.

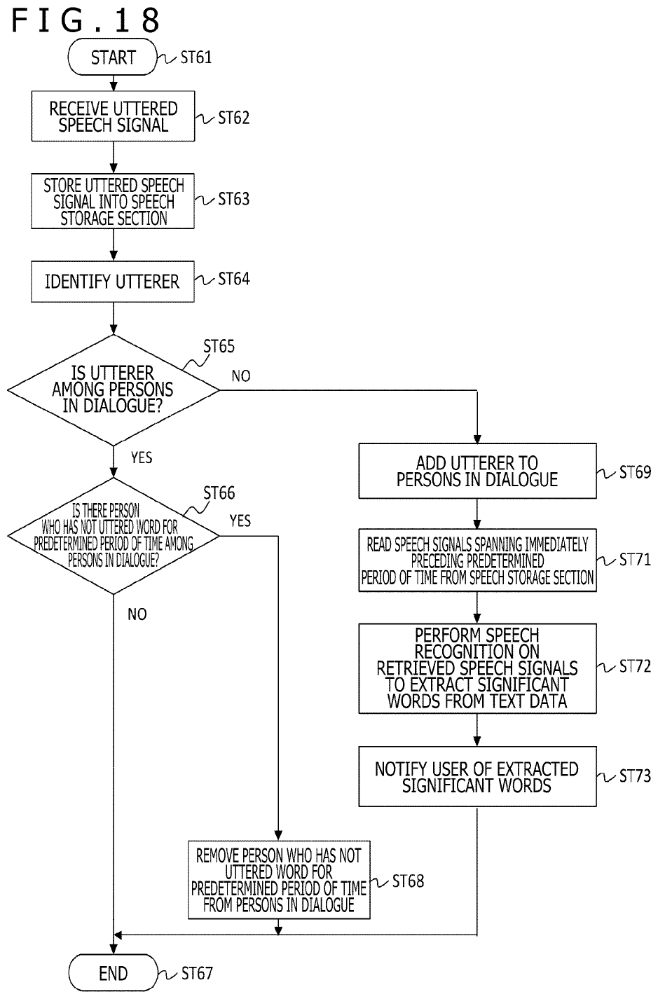

The flowchart of FIG. 18 depicts an example of processing steps performed by the information processing section 100D in the above case in order to update persons in dialogue and call up a keyword for recollection. In FIG. 18, the steps corresponding to those in FIG. 16 are designated by the same reference signs, and their detailed explanations will be omitted below where appropriate. The processing of this flowchart is repeated at predetermined intervals.

Following the process of step ST69, the information processing section 100D immediately goes to step ST71. The other steps are similar to those in the flowchart of FIG. 16.

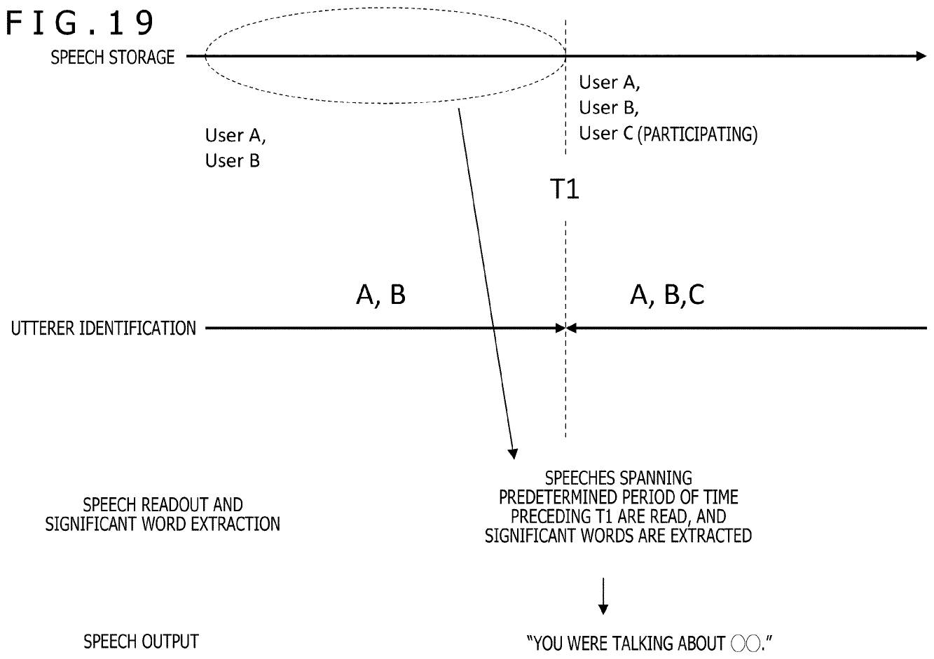

Explained next with reference to FIG. 19 is a specific example of processing performed in the above case. Up to time T1, the users A and B are identified as the persons in dialogue. At time T1, the user C is added to the persons in dialogue. After time T1, the users A, B, and C are identified as the persons in dialogue.

Up to time T1, the dialogue between the users A and B is about the topic of “washing machine” and “drying machine,” for example. For example, the user A may utter “ . . . about how to use the drying machine attached to the washing machine.” In response, the user B may utter “ . . . it may not be a good idea to dry and damage the towels for children.”

In the case where the user C newly participates in dialogue at time T1, the participation of the user C triggers a readout, from the speech storage section 101, of the speech signals spanning an immediately preceding predetermined period of time (i.e., a predetermined period of time preceding time T1), regardless of whether or not the utterance by the user C is indicative of the intention to call up information. The speech recognition section 103 converts the retrieved speech signals into text data, and the significant word extraction section 105 extracts significant words from the text data. For example, “washing machine” and “drying machine” are extracted as the significant words.

The information related to the significant words extracted by the significant word extraction section 105 is sent to the response control section 106. The response control section 106 generates a response sentence including the significant words, and outputs a speech signal corresponding to the response sentence to the speaker 300. For example, a response sentence such as “You were talking about the washing machine and drying machine” is generated, and is audibly output from the speaker 300.

It is to be noted that, when a user newly participates in dialogue, the above-described fourth embodiment notifies the newly participating user of the details of the dialogue between other users either automatically or if the new user's utterance is indicative of the intention to call up information. However, the users currently in dialogue may conceivably not wish to notify a newly participating user of the details of their dialogue. In this case, there may be provided a configuration in which two categories of users are registered beforehand, i.e., those allowed to be notified of the details of the preceding dialogue and those not allowed to be thus notified, and in which whether or not to give notification is determined on the basis of these registrations.

### (Hardware Configuration Example of the Information Processing Section)

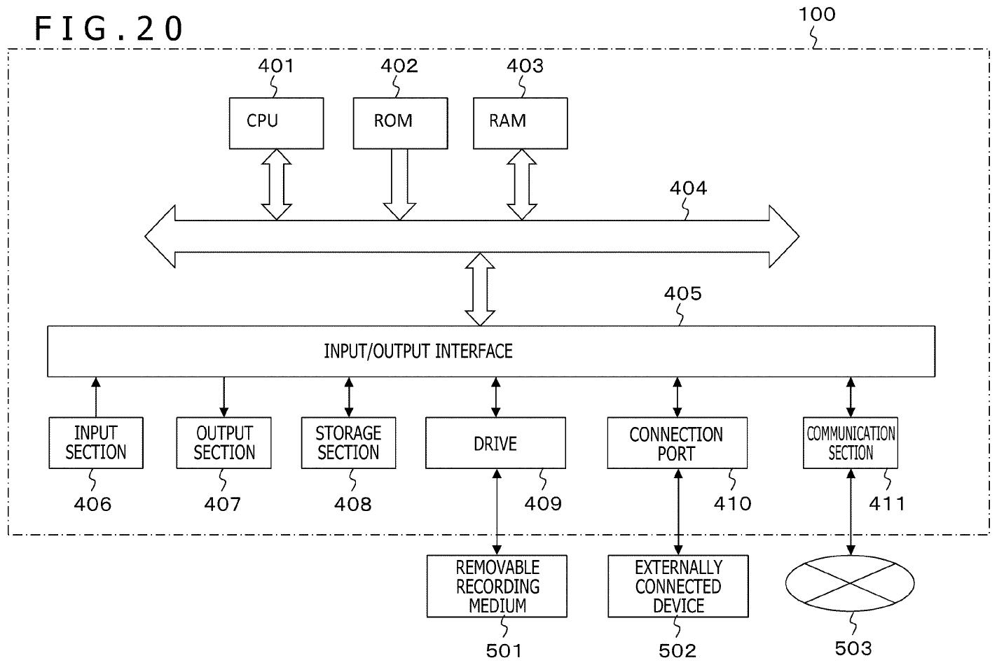

A hardware configuration example of the information processing section 100 (100A, 100A′, 100B to 100D) is explained below. FIG. 20 depicts one hardware configuration example of the information processing section 100.

The information processing section 100 includes a CPU 401, a ROM 402, a RAM 403, a bus 404, an input/output interface 405, an input section 406, an output section 407, a storage section 408, a drive 409, a connection port 410, and a communication section 411. It is to be noted that the hardware configuration in this drawing is only an example and that some of the components thereof may be omitted. The configuration may also include other components in addition to those in the drawing.

The CPU 401 functions as an arithmetic processing apparatus or as a control apparatus, for example. The CPU 401 controls part or all of the operations of the components on the basis of various programs stored in the ROM 402, the RAM 403, or the storage section 408, or recorded on a removable recording medium 501.

The ROM 402 is means for storing the programs to be loaded by the CPU 401 and the data to be used in processing thereby. The RAM 403 stores temporarily or permanently the programs to be loaded by the CPU 401 and diverse parameters to be varied as needed during execution of the programs.

The CPU 401, the ROM 402, and the RAM 403 are interconnected via the bus 404. Meanwhile, a bus 874 is connected with various components via the interface 405.

The input section 406 is configured using, for example, a mouse, a keyboard, a touch panel, buttons, switches, and levers. Further, an input section 878 may be configured using a remote controller (hereinafter, remote control) capable of transmitting control signals by use of infrared rays or other radio waves.

The output section 407 is an apparatus capable of visually or audibly notifying the user of acquired information, such as any one of display apparatuses including a CRT (Cathode Ray Tube), an LCD, and an organic EL; any one of audio output apparatuses including speakers and headphones; a printer, a mobile phone, or a facsimile.

The storage section 408 is an apparatus for storing diverse data. The storage section 408 is configured using, for example, a magnetic storage device such as a hard disk drive (HDD), a semiconductor storage device, an optical storage device, or a magneto-optical storage device.

The drive 409 is an apparatus that writes or reads information to or from the removable recording medium 501 such as a magnetic disk, an optical disk, a magneto-optical disk, or a semiconductor memory.

The removable recording medium 501 is, for example, DVD media, Blu-ray (registered trademark) media, HD DVD media, or diverse semiconductor storage media. Obviously, the removable recording medium 501 may also be an IC card carrying a non-contact IC chip, an electronic device, or the like.

The connection port 410 is, for example, a USB (Universal Serial Bus) port, an IEEE 1394 port, an SCSI (Small Computer System Interface) port, an RS-232C port, an optical audio terminal, or some other appropriate port for connecting with an externally connected device 502. The externally connected device 502 is, for example, a printer, a portable music player, a digital camera, a digital video camera, or an IC recorder.

The communication section 411 is a communication device for connecting with a network 503. For example, the communication section 411 is a communication card for wired or wireless LAN, Bluetooth (registered trademark), or WUSB (Wireless USB) connection; a router for optical communication, a router for ADSL (Asymmetric Digital Subscriber Line), or a modem for diverse communication uses.

### 5. ALTERNATIVE EXAMPLES

It is to be noted that the examples discussed above in connection with the embodiments have indicated that notification is made of significant words extracted from previous speeches, or of the significant words and additional information related thereto as the information regarding a previous dialogue. Alternatively, previous speeches may be audibly output unchanged from the speaker 300 as the information representing such previous speeches.

Whereas some preferred embodiments of the present disclosure have been described above in detail with reference to the accompanying drawings, these embodiments are not limitative of the technical scope of this disclosure. It is obvious that those skilled in the art will easily conceive variations or alternatives of the disclosure within the scope of the technical idea stated in the appended claims. It is to be understood that such variations, alternatives, and other ramifications also fall within the technical scope of the present disclosure.

The advantageous effects stated in this description are only for illustrative purposes and are not limitative of the present disclosure. That is, in addition to or in place of the above-described advantageous effects, the technology of the present disclosure may provide other advantageous effects that will be obvious to those skilled in the art in view of the above description.

It is to be noted that the present technology may be configured preferably as follows:
(1)

An information processing apparatus including:

a control section configured to perform control in such a manner as to give notification of information regarding a previous dialogue on the basis of each status of participants in dialogue.
(2)

The information processing apparatus as stated in paragraph (1) above,

in which the information regarding the previous dialogue includes information regarding a significant word extracted from a speech of the previous dialogue.
(3)

The information processing apparatus as stated in paragraph (2) above,

in which the information regarding the previous dialogue further includes information related to the significant word.
(4)

The information processing apparatus as stated in any one of paragraphs (1) through (3) above, further including:

a speech storage section configured to store a speech spanning a most recent predetermined period of time out of collected speeches,

in which the control section acquires the information regarding the previous dialogue on the basis of the speech stored in the speech storage section.
(5)

The information processing apparatus as stated in any one of paragraphs (1) through (4) above,

in which, when any one of utterers currently in dialogue makes an utterance indicative of intention to call up information, the control section performs control in such a manner as to give notification of the information regarding the previous dialogue in which all utterers currently in dialogue participated.
(6)

The information processing apparatus as stated in any one of paragraphs (1) through (4) above,

in which, when the number of participants in dialogue is changed, the control section performs control in such a manner as to give notification of the information regarding the previous dialogue in which all the utterers currently in dialogue following the change in the number of participants in dialogue participated.
(7)

The information processing apparatus as stated in any one of paragraphs (1) through (4) above,

in which, when there has been no utterance for a predetermined period of time, the control section performs control in such a manner as to give notification of the information regarding the previous dialogue.
(8)

The information processing apparatus as stated in paragraph (7) above,

in which the information regarding the previous dialogue includes information regarding a previous monologue.
(9)

The information processing apparatus as stated in paragraph (8) above,

in which the control section performs control in such a manner as to give notification of the information regarding the previous monologue, before repeatedly giving notification of the information regarding the previous monologue at predetermined intervals until an utterance is made.
(10)

The information processing apparatus as stated in any one of paragraphs (1) through (4) above,

in which, when an utterer newly participates in dialogue, or when an utterer newly participates in dialogue and also makes an utterance indicative of intention to call up information, the control section performs control in such a manner as to give notification of the information regarding a dialogue prior to the participation of the new utterer.
(11)

The information processing apparatus as stated in paragraph (10) above, further including:

an utterer identification section configured to perform utterer identification based on a collected speech signal,

in which, on the basis of the utterer identification performed by the utterer identification section, the control section determines whether an utterer has newly participated in dialogue.
(12)

The information processing apparatus as stated in paragraph (10) or (11) above,

in which, in a case where the control section determines that it is acceptable to notify the utterer newly participating in dialogue of the information regarding the prior dialogue, the control section performs control in such a manner as to give notification of the information regarding the prior dialogue.
(13)

An information processing method including:

a step of performing control in such a manner as to give notification of information regarding a previous dialogue on the basis of each status of participants in dialogue.
(14)

A program for causing a computer to function as:

control means for performing control in such a manner as to give notification of information regarding a previous dialogue on the basis of each status of participants in dialogue.

### REFERENCE SIGNS LIST

10A to 10D: Information processing apparatus

100A, 100A′, 100B to 100D: Information processing section

101: Speech storage section

102: Utterer identification section

103: Speech recognition section

104: Readout control section

105: Significant word extraction section

106: Response control section

107: Additional information acquisition section

200: Microphone

300: Speaker

1. An information processing apparatus comprising:
a control section configured to perform control in such a manner as to give notification of information regarding a previous dialogue on a basis of each status of participants in dialogue.

2. The information processing apparatus according to claim 1,
wherein the information regarding the previous dialogue includes information regarding a significant word extracted from a speech of the previous dialogue.

3. The information processing apparatus according to claim 2,
wherein the information regarding the previous dialogue further includes information related to the significant word.

4. The information processing apparatus according to claim 1, further comprising:
a speech storage section configured to store a speech spanning a most recent predetermined period of time out of collected speeches,
wherein the control section acquires the information regarding the previous dialogue on a basis of the speech stored in the speech storage section.

5. The information processing apparatus according to claim 1,
wherein, when any one of utterers currently in dialogue makes an utterance indicative of intention to call up information, the control section performs control in such a manner as to give notification of the information regarding the previous dialogue in which all utterers currently in dialogue participated.

6. The information processing apparatus according to claim 1,
wherein, when the number of participants in dialogue is changed, the control section performs control in such a manner as to give notification of the information regarding the previous dialogue in which all the utterers currently in dialogue following the change in the number of participants in dialogue participated.

7. The information processing apparatus according to claim 1,
wherein, when there has been no utterance for a predetermined period of time, the control section performs control in such a manner as to give notification of the information regarding the previous dialogue.

8. The information processing apparatus according to claim 7,
wherein the information regarding the previous dialogue includes information regarding a previous monologue.

9. The information processing apparatus according to claim 8,
wherein the control section performs control in such a manner as to give notification of the information regarding the previous monologue, before repeatedly giving notification of the information regarding the previous monologue at predetermined intervals until an utterance is made.

10. The information processing apparatus according to claim 1,
wherein, when an utterer newly participates in dialogue, or when an utterer newly participates in dialogue and also makes an utterance indicative of intention to call up information, the control section performs control in such a manner as to give notification of the information regarding a dialogue prior to the participation of the new utterer.

11. The information processing apparatus according to claim 10, further comprising:
an utterer identification section configured to perform utterer identification based on a collected speech signal,
wherein, on a basis of the utterer identification performed by the utterer identification section, the control section determines whether an utterer has newly participated in dialogue.

12. The information processing apparatus according to claim 10,
wherein, in a case where the control section determines that it is acceptable to notify the utterer newly participating in dialogue of the information regarding the prior dialogue, the control section performs control in such a manner as to give notification of the information regarding the prior dialogue.

13. An information processing method comprising:
a step of performing control in such a manner as to give notification of information regarding a previous dialogue on a basis of each status of participants in dialogue.

14. A program for causing a computer to function as:
control means for performing control in such a manner as to give notification of information regarding a previous dialogue on a basis of each status of participants in dialogue.
